(19) United States
(12) Patent Application Publication
(10) Pub. No.: US 2026/0142391 A1
(43) Pub. Date: May 21, 2026

(54) LEAD WIRE ATTACHMENT COMPONENT FOR ELASTIC SENSORS

(71) Applicants: Daniel Budolak, Tehachapi, CA (US); Jeffery Howell, Tehachapi, CA (US); Erick Rossi De La Fuente, Lancaster, CA (US); Lydia Hantsche, Tehachapi, CA (US)

(72) Inventors: Daniel Budolak, Tehachapi, CA (US); Jeffery Howell, Tehachapi, CA (US); Erick Rossi De La Fuente, Lancaster, CA (US); Lydia Hantsche, Tehachapi, CA (US)

(21) Appl. No.: 18/953,057

(22) Filed: Nov. 19, 2024

(51) Int. Cl. H01R 11/05

(52) U.S. Cl. CPC H01R 11/05; H01R 2201/20

(57) ABSTRACT

A lead wire attachment component for an elastic sensor has an electrically conductive tab portion configured for attaching thereto an electrical conductor, and an electrically conductive sensor contact portion integral with the tab portion and configured to be embedded within the sensor. In one embodiment, the sensor contact portion is a mesh structure having openings sized to allow sensor material to flow through the openings during fabrication of the elastic sensor. In another embodiment, the electrically conductive sensor contact portion has a shaft extending from the tab portion to a distal end, and a multi-hook structure integrally joined to the distal end and configured with a plurality of hooks that extend in multiple dimensions. In another embodiment, the electrically conductive sensor contact portion has a plurality of electrically conductive members that joined to the tab portion and extend in three dimensions. The conductive members may be tendrils or spiral-shaped conductors.

### CROSS-REFERENCES TO RELATED PATENT APPLICATIONS

This application claims priority to the filing date of U.S. provisional patent application No. 63/601,424 , filed Nov. 21, 2023, which application is hereby incorporated by reference in its entirety.

### FIELD OF THE INVENTION

The present invention relates to a lead wire attachment component for elastic sensors.

### BACKGROUND

Elastic, elastomeric, stretchable or soft sensors are used in many fields and industries for measuring various parameters such as strain, pressure, voltage, electrical current, heat, humidity and lumens. Such sensors may be used in wearables (e.g., clothing), soft robotics, implantable medical devices, parachute canopies and other flexible structures. However, attaching electrical wires to the sensor and maintaining acceptable contact resistance between the wires and the sensor poses many problems and challenges. For example, the wire stiffness makes it difficult to reliably embed or bond the wire to the sensor. Such difficulty in embedding or bonding the wire to the sensor may degrade the sensing integrity of the sensor and may also result in a degraded interface between the wire and the soft sensor material. The wires are also unreliable because the wire stiffness makes the wire susceptible to being pulled out of the sensor. One prior art technique used in an attempt to prevent the wires from being pulled out of the sensor entailed the use of clamps for clamping the wires to the sensor. Another prior art technique entailed crimping the wires to the sensor. However, clamping or crimping the wires to the sensor has been known to damage the sensor. Furthermore, when wires are embedded in the sensor, stretching or deformation of the sensor results in a change in the contact resistance between the wire and the sensor. This is illustrated in FIGS. 1A and 1B. FIG. 1A illustrates elastic, elastomeric or stretchable sensor 10 having wire 12 embedded therein. Substantially all portions of wire 12 are in physical contact with sensor 10 thereby providing a high-integrity contact resistance between wire 12 and sensor 10. When sensor 10 is stretched or deformed, as indicated by arrow 14 in FIG. 1B, spaces or gaps 16 and 18 develop between wire 12 and sensor 10 and typically extend along the length of wire 12 thereby significantly changing the contact resistance between wire 12 and sensor 10. The change in contact resistance degrades the sensing capabilities of sensor 10. There have been many prior art techniques developed in an attempt to address the issues of changing contact resistance caused by sensor deformation and inadvertent damage to the sensor that occurs when wires are embedded, bonded or joined to the sensor. One prior art technique entails applying conductive epoxy (e.g., silver loaded epoxy) to the wires. However, once dried, the conductive epoxy is too stiff and typically breaks off or delaminates at high strain. Furthermore, conductive epoxy is typically not compatible with silicone sensors. Another prior art technique entails application of a conductive silicone (e.g., silver loaded silicone) to the wires. However, conductive silicone exhibits unreliable conductivity once cured. Another prior art technique entails the use of conductive tapes to secure the wires to the sensor. However, conductive tapes do not reliably adhere to silicone. Another prior art technique entails wrapping the wires with silver paint interface. However, wrapping the wires with the silver paint interface proved to be very difficult to implement and quite unreliable. Specifically, wrapping the wires too loose will significantly decrease the contact resistance between the wires and the sensor, and wrapping the wires too tight will cause the wires to cut into and damage the sensor. Another prior art technique entails stitching a thin metal wire or conductive thread in or through the sensor. However, such a configuration is prone to drastic changes in contact resistance between the sensor and the metal wire or conductive thread upon deformation of the sensor. Another prior art technique entailed embedding the wires sideways into the sensor during fabrication of the sensor. In one version of this prior art technique, one or more straight, stiff wires are embedded sideways into the sensor. In another version of this prior art technique, known as the “bird cage” or “basket” technique, a wire having braided sections is inserted into the sensor during fabrication of the sensor. Once the wire was embedded into the sensor, the braided sections were opened up or expanded to form a small “basket” or “bird cage” within the body of the sensor thereby increasing the contact between the wire and the sensor. In yet a third version, a loop is formed in the wire and then embedded into the sensor during fabrication of the sensor. The loop approach was basically another attempt to increase the contact between the wires and the sensor. However, each one of these approaches not only failed to resolve the issues of wire-pullout and changing contact resistance due to sensor deformation, but also could not resolve problem of inconsistent and widely varying contact resistance among sensors of the same batch.

### SUMMARY

Disclosed herein are embodiments of a lead wire attachment component for an elastic sensor. In one aspect, the lead wire attachment component comprises an electrically conductive tab portion configured for attaching thereto an electrical conductor, and an electrically conductive sensor contact portion integrally joined to the tab portion and configured to be embedded within an elastic sensor. The sensor contact portion comprises a mesh structure having a plurality of openings. The openings in the mesh structure are sized to allow sensor material to flow through the openings during fabrication of the elastic sensor. In some embodiments, the mesh structure is configured such that the openings are arranged in rows and columns. Each opening in the mesh structure may have any suitable shape including, but not limited to, circular, oval, square, rectangular and triangular. In some embodiments, the mesh structure has a first width and the tab portion has a second width that is substantially equal to the first width. In some embodiments, the tab portion has an outer end that is configured with a curvature.

In another aspect, the lead wire attachment component for an elastic sensor comprises an electrically conductive tab portion configured for attaching thereto an electrical conductor, and an electrically conductive sensor contact portion integrally joined to the tab portion and configured to be embedded within an elastic sensor. The sensor contact portion comprises a shaft that extends to an end portion, and a multi-hook structure integrally joined to the end portion of the shaft and configured with a plurality of hooks that extend in multiple dimensions. In one embodiment, the multi-hook structure is configured as a two-dimensional structure and has two hooks that are 180° apart. In another embodiment, the multi-hook structure is configured as a three-dimensional structure and has a plurality of spaced hooks. In an exemplary embodiment, there are four hooks. In some embodiments, the hooks are equidistantly spaced. In other embodiments, the hooks are unequally spaced or stochastically spaced.

In a further aspect, the lead wire attachment component for use with an elastic sensor comprises an electrically conductive tab portion configured for attaching thereto an electrical conductor, and an electrically conductive sensor contact portion integrally joined to the tab portion and configured to be embedded within an elastic sensor. The sensor contact portion comprises a plurality of electrically conductive members that are joined to the tab portion and extend in three dimensions. In one embodiment, the plurality of electrically conductive members comprises a plurality of tendrils. In another embodiment, the plurality of electrically conductive members comprises a plurality of spiral-shaped conductors. In some embodiments, the tab portion has a first end to which the electrically conductive members are joined and an opposite second end that is configured with a curvature. In some embodiments, the tab portion is fabricated from a stiff electrically conductive material.

Certain features and advantages of the present invention have been generally described in this summary section. However, additional features, advantages and embodiments are presented herein or will be apparent to one of ordinary skill of the art in view of the drawings, specification and claims hereof. Accordingly, it should be understood that the scope of the invention shall not be limited by the particular embodiments disclosed in this summary section.

### BRIEF DESCRIPTION OF THE DRAWINGS

FIG. 1A illustrates a side view of an undeformed elastic sensor having a wire embedded therein in accordance with a prior art technique, wherein the wire fully contacts the elastic sensor;

FIG. 1B illustrates the elastic sensor of FIG. 1A in a deformed or stretched state, wherein portions of the wire no longer contact the elastic sensor thereby degrading the contact resistance between the wire and the elastic sensor;

FIG. 2A is a front elevational view of a lead wire attachment component for an elastic sensor in accordance with an embodiment of the present disclosure, the rear elevational view being essentially the same as the front elevational view;

FIG. 2B is a perspective view of the lead wire attachment component of FIG. 2A;

FIG. 2C is a perspective view showing the lead wire attachment component of FIG. 2A partially embedded in an elastic sensor;

FIG. 2D illustrates the elastic sensor and lead wire attachment component shown in FIG. 2C with a wire soldered to the tab portion of the lead wire attachment component;

FIG. 2E is a front elevational view of a lead wire attachment component in accordance an embodiment of the present disclosure, the rear elevational view being essentially the same as the front elevational view;

FIG. 2F is a graph of gauge factor values for an elastic sensor having embedded therein standard copper lead wires in accordance with prior art techniques;

FIG. 2G is a graph of gauge factor values for the same elastic sensor referenced in FIG. 2F wherein the mesh structure of the lead wire attachment component of FIG. 2A was embedded in the elastic sensor instead of the standard copper lead wires;

FIG. 3A is a perspective view of a lead wire attachment component for an elastic sensor in accordance with an embodiment of the present disclosure;

FIG. 3B is a perspective view of the lead wire attachment component of FIG. 3A partially embedded in an elastic sensor;

FIG. 4A is a perspective view of a lead wire attachment component in accordance with an embodiment of the present disclosure;

FIG. 4B is a perspective view of the lead wire attachment component of FIG. 4A partially embedded in an elastic sensor;

FIG. 5A is a perspective view of a lead wire attachment component in accordance with an embodiment of the present disclosure;

FIG. 5B is a perspective view of the lead wire attachment component of FIG. 5A partially embedded in an elastic sensor;

FIG. 6A is a perspective view of a lead wire attachment component in accordance with an embodiment of the present disclosure; and

FIG. 6B is a perspective view of the lead wire attachment component of FIG. 6A partially embedded in an elastic sensor.

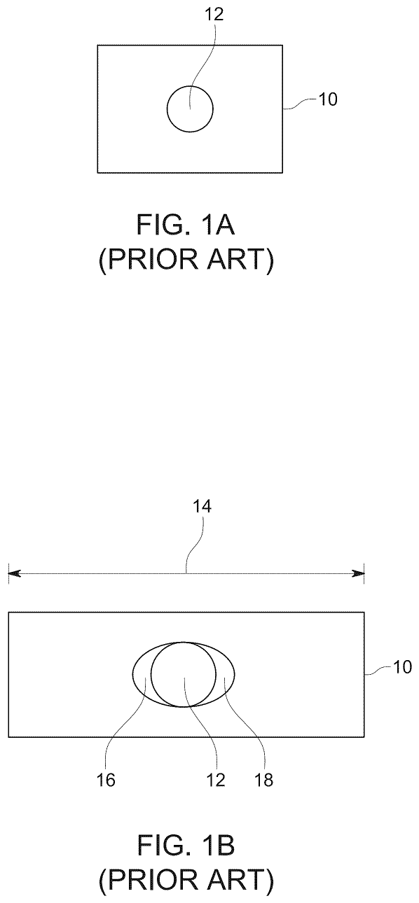

### DESCRIPTION OF EMBODIMENTS

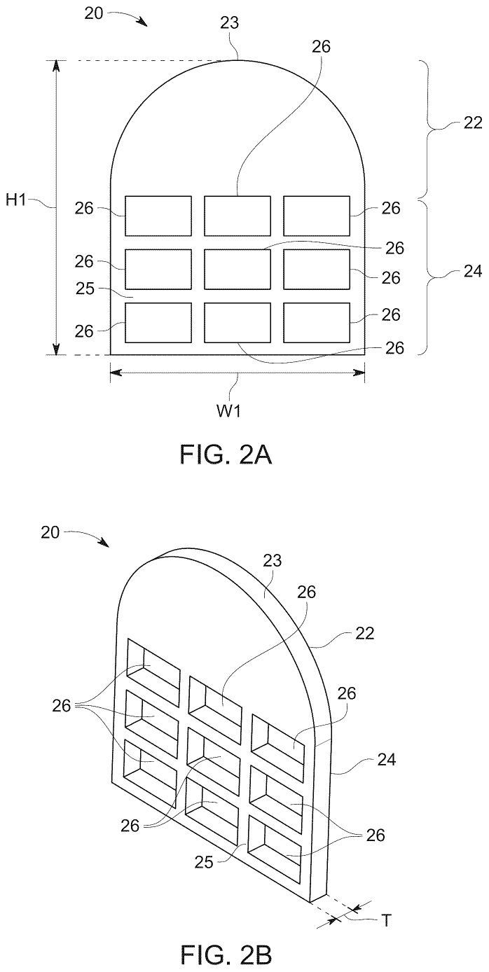

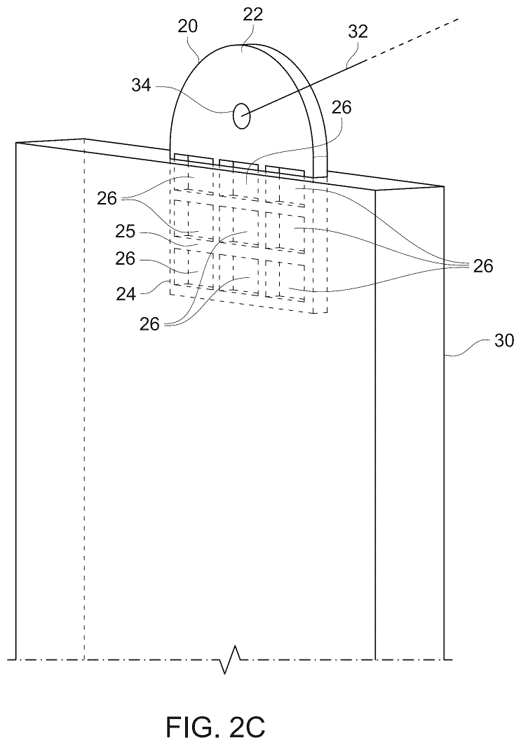

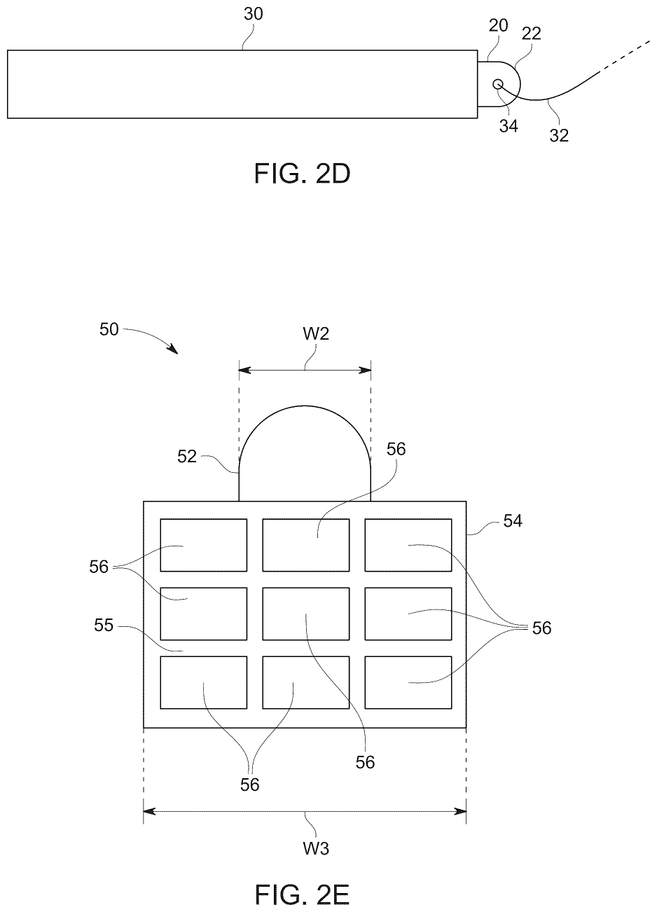

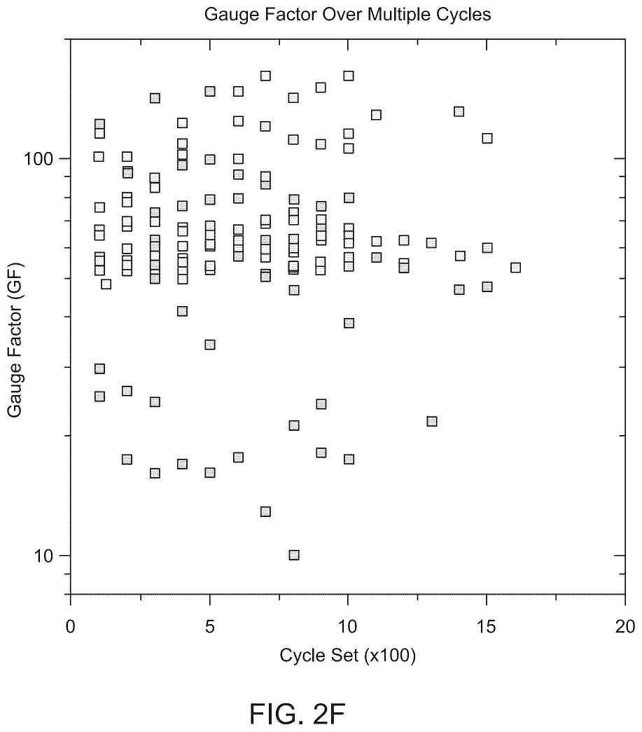

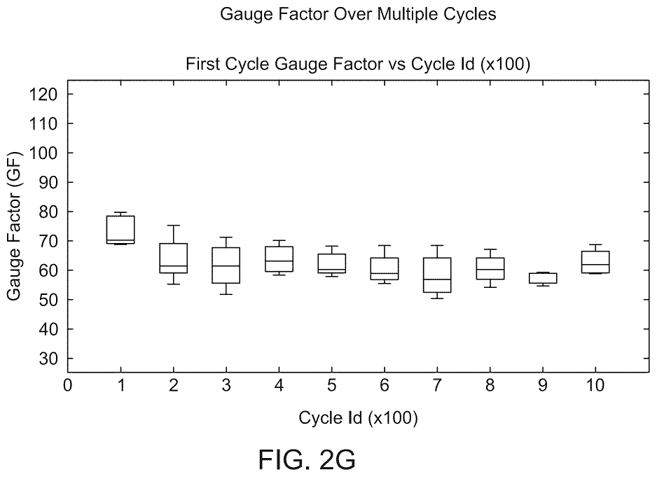

For purposes of description herein, the terms “upper,” “lower,” “right,” “left,” “rear,” “front,” “vertical,” “horizontal,” and derivatives thereof shall relate to the lead wire attachment component as oriented in FIGS. 2A, 3A, 4A, 5A and 6A. However, it is to be understood that the invention may assume various alternative orientations and step sequences, except where expressly specified to the contrary. It is also to be understood that the specific components, devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “sensor material” refers to the material or materials used to fabricate stretchable sensors, flexible sensors, flexible substrate sensors, soft sensors or elastomeric sensors.

Disclosed herein are embodiments of a lead wire attachment component for use with elastic sensors, also known as stretchable sensors, flexible sensors, flexible substrate sensors, soft sensors or elastomeric sensors. Such sensors typically have conductive filler elements such as graphene, carbon, carbon nanotubes (CNT), silver flakes and/or silver nanoparticles that are embedded in elastomeric, flexible or stretchable materials including, but not limited to, silicone, polydimethysiloxane (PDMS), polyeurethane and any thermoplastic elastomer (TPE).

Referring to FIGS. 2A-C, there is shown lead wire attachment component 20 in accordance with an exemplary embodiment of the present disclosure. Component 20 comprises electrically conductive tab portion 22. Wires or other electrical conductors may be electrically attached or joined to tab portion 22 via soldering techniques or other suitable techniques. In some embodiments, tab portion 20 is fabricated from a stiff electrically conductive material to facilitate soldering wires to tab portion 20 using traditional soldering techniques. In some embodiments, tab portion 22 is substantially flat. In an exemplary embodiment, end 23 of tab portion 22 is configured with a curvature in order to reduce sharp or pointed edges. In other embodiments, end 23 does not have a curvature and is configured to be substantially straight. Component 20 further comprises electrically conductive sensor contact portion 24. In some embodiments, sensor contact portion 24 is integral with tab portion 22. In other embodiments, sensor contact portion 24 is attached or connected to tab portion 22. Sensor contact portion 24 is completely embedded in elastic sensor 30 during the fabrication of elastic sensor 30 (see FIG. 2C). Sensor contact portion 24 comprises mesh structure 25 that provides a relatively large surface area for contacting elastic sensor 30 thereby providing high-integrity contact resistance between elastic sensor 30 and mesh structure 25. Mesh structure 25 is configured with a plurality of openings 26. The size of each opening 26 depends upon the density of the material from which elastic sensor 30 is fabricated. During fabrication of elastic sensor 30, the material of elastic sensor 30 fills openings 26 and envelops mesh structure 25 thereby producing a strong bond between mesh structure 25 and the elastic sensor material. Such a strong bond also provides consistent and high-integrity contact resistance between mesh structure 25 and the sensor material. In this embodiment, openings 26 are rectangular shaped and arranged in rows and columns. However, in other embodiments, openings 26 may have other shapes including, but not limited to, circular, oval, square, triangular, fractal or any irregular shape. Openings 26 may be arranged in formations other than rows and columns. In some embodiments, openings 26 are stochastically arranged. In some embodiments, mesh structure 25 is configured to have nine openings 26 as shown in FIGS. 2A-B. In other embodiments, mesh structure 25 may have less than or more than nine openings therein.

In some embodiments, component 20 is fabricated from electrically conductive metals. Examples of electrically conductive metals include, but are not limited to, copper, gold, brass, silver and aluminum. In one embodiment, component 20 is fabricated from copper. In such an embodiment, the portion of the copper used to form tab portion 22 is relatively stiff so as allow one or more wires to be soldered to tab portion 22 using traditional wire solder techniques. This is illustrated in FIGS. 2C and 2D wherein wire 32 is joined to tab portion 22 via solder 34. However, wire 32 may be joined or attached to tab portion 22 via other suitable techniques as well.

As shown in FIGS. 2C-D, tab portion 22 is external to elastic sensor 30 and sensor contact section 24, shown in phantom in FIG. 2C, is completely embedded within elastic sensor 30. The selection of width W1, height H1 and thickness T of component 20 (see FIGS. 2A-B) is based upon the size and thickness of elastic sensor 30. Component 20 is configured to have a size that allows the elastic sensor material to completely envelop the entire mesh structure 25 of sensor contact portion 24 and fill openings 26 so as to produce a strong bond between the elastic sensor material and sensor contact portion 24. The width W1 of component 20 may be either less than or substantially the same as the width of elastic sensor 30. In an exemplary embodiment, component 20 is configured so that tab portion 22 has the same width as sensor contact portion 24, as shown in FIGS. 2A-C. In other embodiments, component 20 is configured so that the width of tab portion 22 is less than the width of sensor contact portion 24. Such an embodiment is shown in FIG. 2E wherein lead wire attachment component tab 50 comprises tab portion 52 which has the same purpose and function as tab portion 22. Component 50 further comprises sensor contact portion 54 which has the same purpose, function and structure of sensor contact portion 24. Mesh structure 55 of sensor contact portion 54 is configured with a plurality of openings 56 that serve the same purpose as openings 26 of mesh structure 25 of sensor contact portion 24. In this embodiment, the width W2 of tab portion 52 is less than the width W3 of sensor contact portion 54. Component 50 may be fabricated from any of the aforementioned stiff conductive materials. In one embodiment, component 50 is fabricated from copper so that one or more wires may be soldered to tab portion 52 using traditional wire solder techniques.

FIG. 2F is a graph showing gauge factor (sensitivity) values for a flexible sensing substrate (elastic sensor) when standard copper lead wires are embedded into the elastic sensor in accordance with the prior art techniques. Gauge factor values were obtained over multiple cycles and, as shown in the graph, have significant variation. FIG. 2G is a graph showing gauge factor values for the same flexible sensing substrate when lead wire attachment component 20 was used instead of standard copper lead wires. Gauge factor values were obtained over multiple cycles. As shown by the graph in FIG. 2G, there was significantly less variation in the gauge factor values in comparison to the gauge factor values shown FIG. 2F. This significant decrease in the variation of gauge factor values is the direct result of the consistent contact resistance produced by mesh structure 25 of component 20.

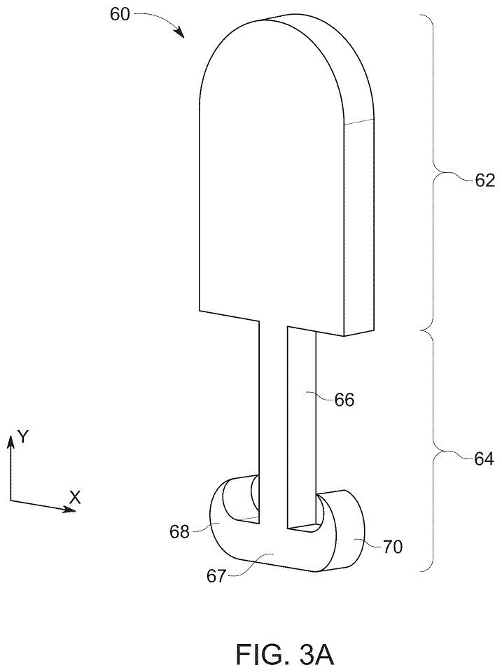

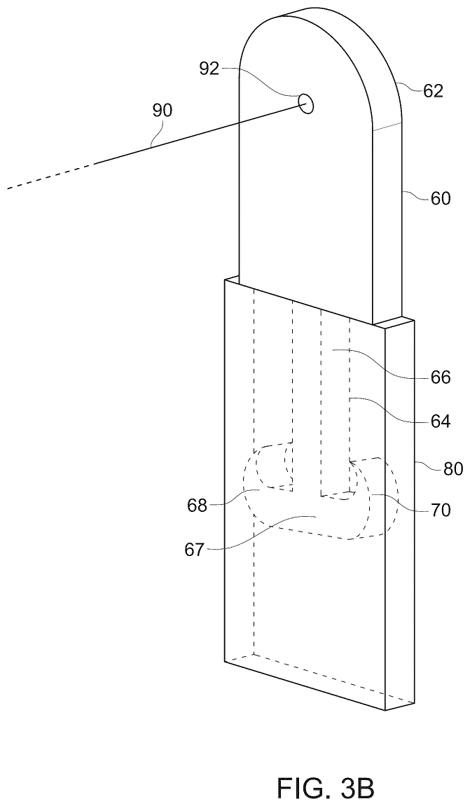

Referring to FIGS. 3A-B, there is shown lead wire attachment component 60 in accordance with another exemplary embodiment of the present disclosure. Component 60 comprises electrically conductive tab portion 62. Wires or other electrical conductors may be attached or joined to tab portion 62 via soldering or other suitable techniques. Component 60 further comprises electrically conductive sensor contact portion 64. In some embodiments, sensor contact portion 64 is integral with tab portion 62. In other embodiments, sensor contact portion 64 is attached or connected to tab portion 62. During fabrication of elastic sensor 80, sensor contact portion 64 is completely embedded in the material from which elastic sensor 80 is fabricated (see FIG. 3B). Sensor contact portion 64 comprises shaft 66 that extends to an end portion and a two-dimensional, multi-hook structure 67 that is located at the end portion of shaft 66. In some embodiments, multi-hook structure 67 is integral with shaft 66. In other embodiments, multi-hook structure 67 is attached or connected to shaft 66. Multi-hook structure 67 comprises a pair of hook portions 68 and 70 that extend in opposite directions in the X-axis and then curl upward in the Y-axis. Hook portions 68 and 70 may be configured with any suitable radius and may extend in the Y-axis for any suitable distance. As shown in FIG. 3A, hooks 68 and 70 are 180° apart. The purpose of multi-hook hook structure 67 is to resist axial pulling in the Y-axis direction. Sensor contact portion 64 provides a relatively large surface area that is enveloped by the sensor material during the fabrication of elastic sensor 80 thereby producing a strong bond that prevents component 60 from being pulled out of elastic sensor 80. This strong bond also produces consistent and high-integrity contact resistance between elastic sensor 80 and sensor contact portion 64.

In some embodiments, component 60 is fabricated from electrically conductive metals. Examples of electrically conductive metals include, but are not limited to, copper, gold, brass, silver and aluminum. In one embodiment, component 60 is fabricated from copper. In such an embodiment, the portion of the copper used to form tab portion 62 is relatively stiff so as allow one or more wires to be soldered to tab portion 62 using traditional wire solder techniques. This is illustrated in FIG. 3B wherein wire 90 is joined to tab portion 62 via solder 92. However, wire 90 may be joined or attached to tab portion 62 via other suitable techniques. Electrical signals produced by sensor 80 are coupled to multi-hook structure 67 and then pass through shaft section 66 and to tab portion 62. Wire 90 routes these electrical signals to external devices, components or circuits.

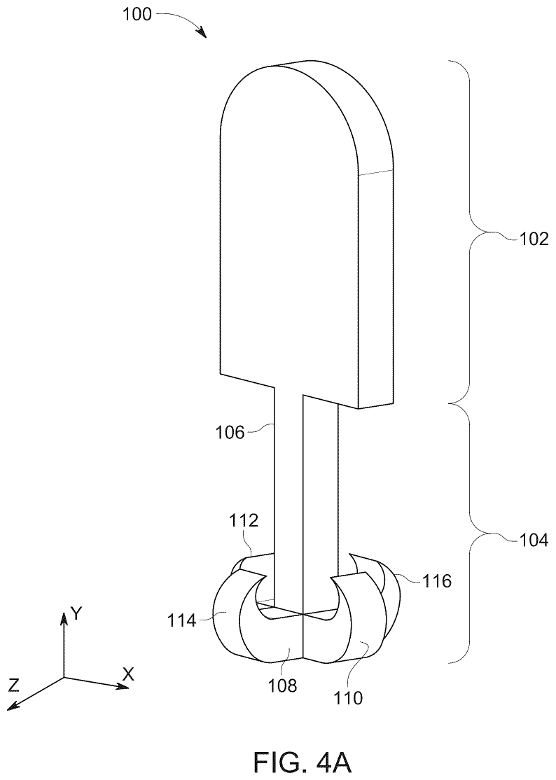

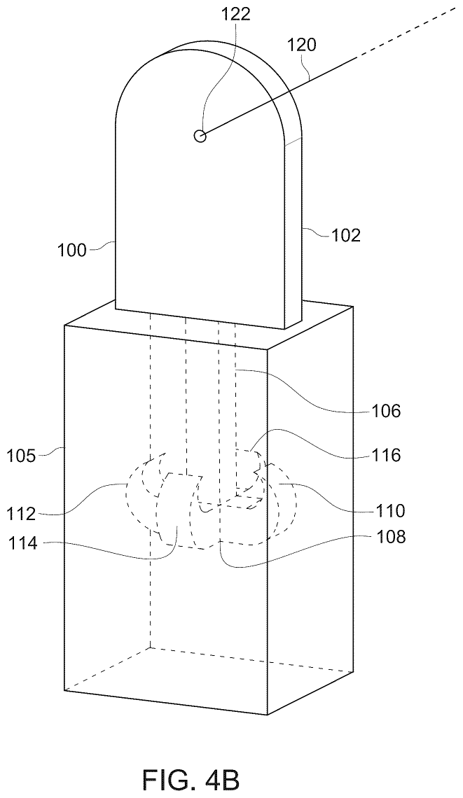

Referring to FIGS. 4A-B, there is shown lead wire attachment component 100 in accordance with another exemplary embodiment of the present disclosure. Component 100 comprises electrically conductive tab portion 102. Wires or other electrical conductors may be attached or joined to tab portion 102 via soldering or other suitable techniques. Component 100 further comprises electrically conductive sensor contact portion 104. In some embodiments, sensor contact portion 104 is integral with tab portion 102. In other embodiments, sensor contact portion 104 is attached or connected to tab portion 102. During fabrication of elastic sensor 105, sensor contact portion 104 is completely embedded in the material from which elastic sensor 105 is fabricated (see FIG. 4B). Sensor contact portion 104 comprises shaft 106 and three-dimensional, multi-hook structure 108 that is located at the end portion of shaft 106. In some embodiments, multi-hook structure 108 is integral with shaft 106. In other embodiments, multi-hook structure 108 is attached or connected to shaft 106. In an exemplary embodiment, multi-hook structure 108 comprises four hook portions 110, 112, 114 and 116. In an exemplary embodiment, as shown in FIG. 4A, hook portions 110, 112, 114 and 116 are equidistantly spaced. In other embodiments, hook portions 110, 112, 114 and 116 are unequally spaced or stochastically spaced. Hook portion 110 extends in a first direction along the X-axis and then curls upward in the Y-axis. Hook portion 112 extends in an opposite second direction along the X-axis and then curls upward in the Y-axis. Hook portions 110 and 112 may be configured with any suitable radius and may extend in the Y-axis for any suitable distance. Hook portion 114 extends in a first direction along the Z-axis and then curls upward in the Y-axis. Hook portion 116 extends in an opposite second direction along the Z-axis and then curls upward in the Y-axis. Hook portions 114 and 116 may be configured with any suitable radius and may extend in the Y-axis for any suitable distance. The purpose of multi-hook structure 108 is to resist axial pulling in the Y-axis direction. The configuration of sensor contact portion 104 provides a relatively large surface area that is enveloped by the sensor material during the fabrication of elastic sensor 105. When the material of elastic sensor 105 envelopes multi-hook structure 108, a strong bond is created thereby preventing component 100 from being pulled out of elastic sensor 105. This strong bond also produces consistent and high-integrity contact resistance between sensor contact portion 104 and elastic sensor 105. Since hook portions 114 and 116 extend along the Z-axis, component 100 is well suited for use in relatively thick elastic sensors.

In some embodiments, component 100 is fabricated from electrically conductive metals. Examples of electrically conductive metals include, but are not limited to, copper, gold, brass, silver and aluminum. In one embodiment, component 100 is fabricated from copper. In such an embodiment, the portion of the copper used to form tab portion 102 is relatively stiff so as allow one or more wires to be soldered to tab portion 102 using traditional wire solder techniques. This is illustrated in FIG. 4B wherein wire 120 is joined to tab portion 102 via solder 122. However, wire 120 may be joined or attached to tab portion 102 via other suitable techniques. Electrical signals produced by elastic sensor 105 are coupled to multi-hook structure 108 and then pass through shaft section 106 and to tab portion 102. Wire 120 routes these electrical signals to external devices, components or circuits.

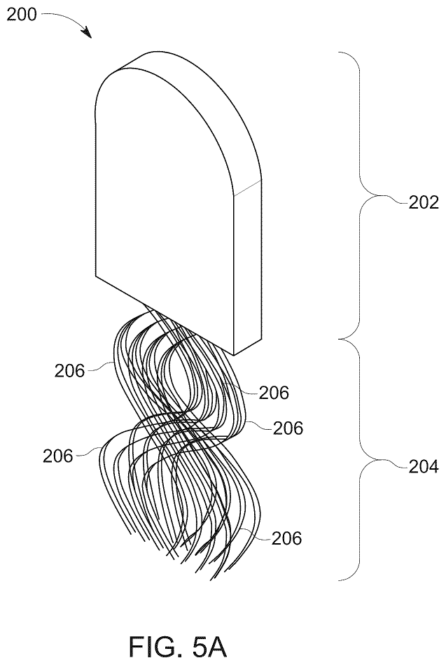

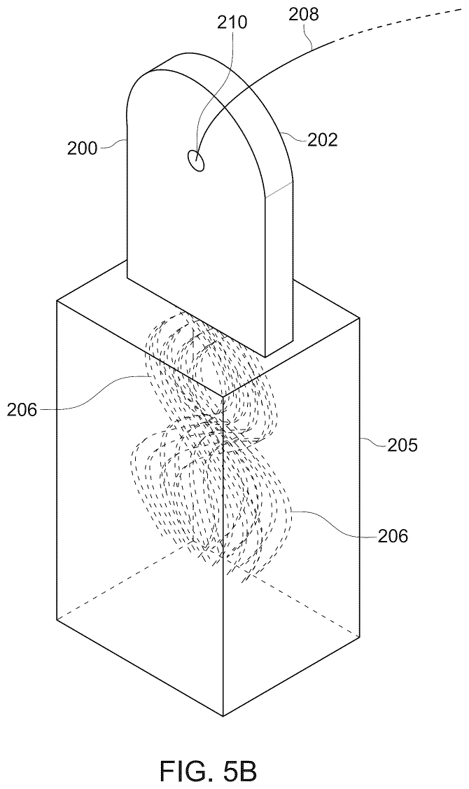

Referring to FIGS. 5A-B, there is shown lead wire attachment component 200 in accordance with another exemplary embodiment of the present disclosure. Component 200 comprises tab portion 202. Wires or other electrical conductors may be attached or joined to tab portion 202 via soldering or other suitable techniques. In some embodiments, tab portion 202 is fabricated from a stiff conductive material such as a stiff conductive metal. The stiffness of the conductive metal facilitates soldering wires to tab portion 202 using traditional soldering techniques. In one embodiment, tab portion 202 is fabricated from copper. Lead wire attachment component 200 further comprises sensor contact portion 204. Sensor contact portion 204 comprises a plurality of electrically conductive members 206 that are joined to electrically conductive tab portion 202 via any suitable technique. Conductive members 206 are completely embedded in elastic sensor 205 during the fabrication of elastic sensor 205 (see FIG. 5B). Conductive members 206 are configured as tendrils (hereinafter referred to as “tendrils 206”). Tendrils 206 may be fabricated via techniques known in the art. For example, in one embodiment, each tendril 206 is formed by fusing conductive yarns into a tendril configuration. The conductive yarn may be a blend of conductive materials and traditional textile fibers. Examples of conductive materials include, but are not limited to, metals, carbon fibers, conductive alloys and metal carbon/nitride. Examples of suitable metals include, but are not limited to, copper, silver and gold. Tendrils 206 may also be formed by mixing the aforementioned conductive materials with elastic materials. Examples of elastic materials include, but are not limited to, epoxy resin, thermoplastic and thermosetting elastomers and rubber. Tendrils 206 are flexible and may be configured in any random and/or stochastic arrangement emanating from the tab portion 202. Tendrils 206 extend in three dimensions (i.e. X, Y and Z axes). Tendrils 206 are configured with a density that is based on the density of the sensor material of elastic sensor 205. The quantity, shape, spacing and length of tendrils 206 are chosen so as to allow the sensor material of elastic sensor 205 to flow in between and around tendrils 206 so as to envelope tendrils 206 and produce a strong bond between tendrils 206 and the sensor material. Such a strong bond results in consistent and high-integrity contact resistance between the sensor material and tendrils 206. FIG. 5B shows component 200 attached to elastic sensor 205 wherein tendrils 206 (shown in phantom) are completed embedded in the sensor material of elastic sensor 205. Wire 208 is joined to tab portion 202 via solder 210. However, it is to be understood that other techniques may be used to attach or join wire 208 to tab portion 202. Electrical signals produced by elastic sensor 205 are coupled to tendrils 206. Since tendrils 206 are in electrical contact with tab portion 202, an electrically conductive path is formed from tendrils 206 to tab portion 202. Therefore, electrical signals generated by elastic sensor 205 are available at tab portion 202. Wire 208 routes these electrical signals to external devices, components or circuits.

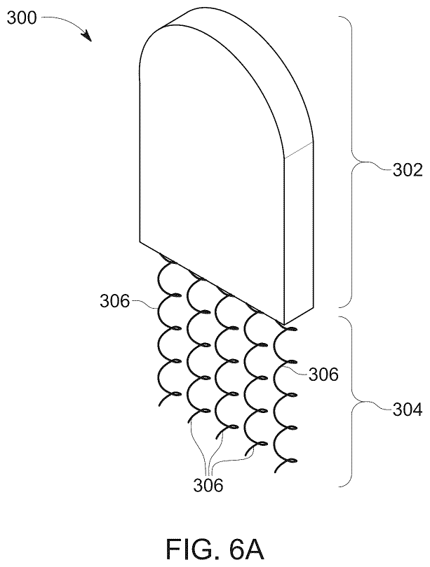

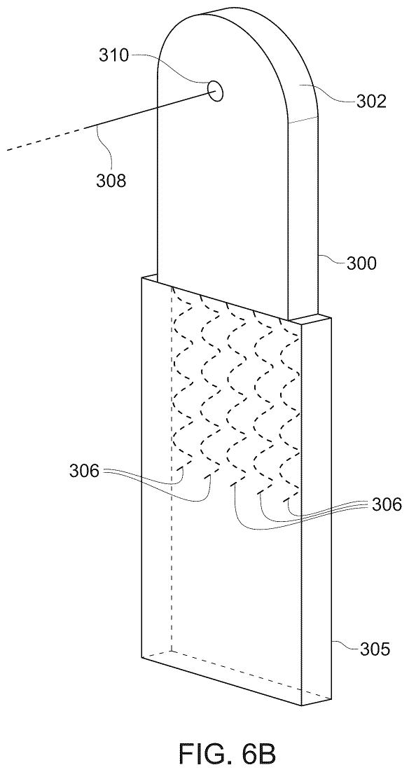

Referring to FIGS. 6A-B, there is shown lead wire attachment component 300 in accordance with another exemplary embodiment of the present disclosure. Component 300 comprises tab portion 302. Wires or other electrical conductors may be attached or joined to tab portion 302 via soldering or other suitable techniques. In some embodiments, tab portion 302 is fabricated from a stiff conductive material such as a stiff conductive metal. The stiffness of the conductive metal facilitates soldering wires to tab portion 302 using traditional soldering techniques. In one embodiment, tab portion 302 is fabricated from copper. Lead wire attachment component 300 further comprises sensor contact portion 304 that is configured to be completely embedded in elastic sensor 305 during the fabrication of elastic sensor 305 (see FIG. 6B). Sensor contact portion 304 comprises a plurality of electrically conductive members 306 that are joined to electrically conductive tab portion 302 via any suitable technique. Conductive members 306 are configured as spiral-shaped conductors (hereinafter referred to as “spiral conductors 306”). Spiral conductors 306 are fabricated from electrically conductive materials and may be formed using any suitable technique known in the art. Examples of suitable electrically conductive materials include, but are not limited to, carbon-based materials, copper, silver, gold, and aluminum. Carbon-based materials include, but are not limited to, graphite, graphene and carbon nanotubes (CNT). Spiral conductors 306 are flexible and may be arranged in a straight line as shown in FIG. 6A, or in any random and/or stochastic arrangement emanating from the tab portion 302. The spiral geometry of the spiral conductors 306 results in each spiral conductor extending in three dimensions (i.e. X, Y and Z axes). Spiral conductors 306 are flexible and configured with a density that is based on the density of the sensor material of elastic sensor 305. The quantity, shape, spacing and length of spiral conductors 306 are chosen so as to allow the sensor material of elastic sensor 305 to flow in between and around spiral conductors 306 so as to envelope spiral conductors 306 and produce a strong bond between spiral conductors 306 and the sensor material. Such a strong bond results in consistent and high-integrity contact resistance between the sensor material and spiral conductors 306. Although component 300 is shown using five spiral conductors 306, it is to be understood that there may be more or less than five spiral conductors 306. FIG. 6B shows component 300 attached to elastic sensor 305 wherein spiral conductors 306 (shown in phantom) are completed embedded in the sensor material of elastic sensor 305. Wire 308 is joined to tab portion 302 via solder 310. However, it is to be understood that other techniques may be used to attach or join wire 308 to tab portion 302. Electrical signals produced by elastic sensor 305 are coupled to spiral conductors 306. Since spiral conductors 306 electrically contact tab portion 302, an electrically conductive path is formed from spiral conductors 306 to tab portion 302. Therefore, electrical signals generated by elastic sensor 305 are available at tab portion 302. Wire 308 routes these electrical signals to external devices, components or circuits.

Although electrically conductive members 306 are described as having a spiral geometrical shape, it is to be understood that electrically conductive members 306 may have other geometrical shapes as well. For example, each electrically conductive member 306 may be configured to have a helical shape.

As used herein, the terms “comprise”, “comprising”, “comprises”, “includes”, “including”, “has”, “having” or any other variation thereof, are intended to cover a non-exclusive inclusion. For example, a process, method, article or apparatus that comprises a list of elements is not necessarily limited to only those elements, but may include other elements not expressly listed or inherent to such process, method, article or apparatus.

The use of the terms “a” and “an” and “the” and similar references in the context of describing the embodiments (especially in the context of the following claims) are to be construed to cover both the singular and the plural, unless otherwise indicated herein or clearly contradicted by context. The term “or” shall be construed to mean “and/or”. As used herein, the term “and/or” includes any and all combinations of one or more of the associated listed items. The terms “first”, “second”, and the like herein do not denote any order, quantity or importance, but rather are used to distinguish one element from another. Furthermore, approximating language, as used herein throughout the specification and claims, may be applied to modify any quantitative representation that could permissibly vary without resulting in a change in the basic function to which it is related. Accordingly, a value modified by a term such as “about” or “approximately” is not limited to the precise value specified.

Reference in the specification to “an exemplary embodiment”, “one embodiment”, “an embodiment” or “some embodiments”, means that a particular feature, structure or characteristic described in connection with the embodiment is included in at least one embodiment of the present disclosure. The appearances of the phrases “an exemplary embodiment”, “one embodiment”, “embodiment” or “some embodiments” in various places in the specification are not necessarily all referring to the same embodiment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A lead wire attachment component for an elastic sensor, comprising:
an electrically conductive tab portion configured for attaching thereto an electrical conductor; and
an electrically conductive sensor contact portion integrally joined to the tab portion and configured to be embedded within an elastic sensor, the sensor contact portion comprising a mesh structure having a plurality of openings, wherein the openings in the mesh structure are sized to allow sensor material to flow through the openings during fabrication of the elastic sensor.

2. The lead wire attachment component according to claim 1 wherein the mesh structure is configured such that the openings are arranged in rows and columns.

3. The lead wire attachment component according to claim 1 wherein the openings in the mesh structure are stochastically arranged.

4. The lead wire attachment component according to claim 1 wherein the mesh structure has a first width and the tab portion has a second width that is substantially equal to the first width.

5. The lead wire attachment component according to claim 1 wherein the mesh structure has a first width and the tab portion has a second width that is less than the first width.

6. The lead wire attachment component according to claim 1 wherein the tab portion is fabricated from a stiff electrically conductive material.

7. The lead wire attachment component according to claim 1 wherein the tab portion is fabricated from an electrically conductive metal chosen from the group consisting of copper, silver, gold, brass and aluminum.

8. A lead wire attachment component for an elastic sensor, comprising:
an electrically conductive tab portion configured for attaching thereto an electrical conductor; and
an electrically conductive sensor contact portion integrally joined to the tab portion and configured to be embedded within an elastic sensor, the sensor contact portion comprising:
a shaft extending from the tab portion to an end portion, and
a multi-hook structure integrally joined to the end portion of the shaft and configured with a plurality of hooks that extend in multiple dimensions.

9. The lead wire attachment component according to claim 8 wherein the multi-hook structure is configured as a two-dimensional structure.

10. The lead wire attachment component according to claim 9 wherein the multi-hook structure is configured with two hooks.

11. The lead wire attachment component according to claim 8 wherein the multi-hook structure is configured as a three-dimensional structure.

12. The lead wire attachment component according to claim 11 wherein the three-dimensional structure is configured with four hooks.

13. The lead wire attachment component according to claim 11 wherein the three-dimensional structure is configured with four equidistantly spaced hooks.

14. The lead wire attachment component according to claim 11 wherein the three-dimensional structure is configured with four unequally spaced hooks.

15. A lead wire attachment component for use with an elastic sensor, comprising:
an electrically conductive tab portion configured for attaching thereto an electrical conductor; and
an electrically conductive sensor contact portion integrally joined to the tab portion and configured to be embedded within an elastic sensor, the sensor contact portion comprising a plurality of electrically conductive members that are joined to the tab portion and extend in three dimensions.

16. The lead wire attachment component according to claim 15 wherein the plurality of electrically conductive members comprises a plurality of tendrils.

17. The lead wire attachment component according to claim 15 wherein the plurality of electrically conductive members comprises a plurality of spiral-shaped conductors.

18. The lead wire attachment component according to claim 15 wherein the tab portion has a first end to which the electrically conductive members are joined and an opposite second end that is configured with a curvature.

19. The lead wire attachment component according to claim 15 wherein the tab portion is fabricated from a stiff electrically conductive material.

20. The lead wire attachment component according to claim 15 wherein the tab portion and sensor contact portion are fabricated from an electrically conductive material chosen from the group consisting of copper, silver, gold, brass and aluminum.
